(19) United States
(12) Patent Application Publication
(10) Pub. No.: US 2009/0132326 A1
(43) Pub. Date: May 21, 2009

(54) INTEGRATING ADS WITH MEDIA

(75) Inventors: James M. Alkove, Bellevue, WA (US); James E. Allard, Seattle, WA (US); David Sebastien Alles, Seattle, WA (US); Adam Tipton Berns, Bellevue, WA (US); Steven Drucker, Bellevue, WA (US); Julio Estrada, Redmond, WA (US); Todd Eric Holmdahl, Redmond, WA (US); Oliver R. Roup, Boston, MA (US); David Hendler Sloo, Menlo Park, CA (US); Curtis G. Wong, Medina, WA (US); Dawson Yee, Bellevue, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/941,305

(22) Filed: Nov. 16, 2007

(51) Int. Cl. G06Q 30/00; G06Q 10/00; G06Q 40/00

(52) U.S. Cl. 705/9; 705/1; 705/14; 705/37

(57) ABSTRACT

The claimed subject matter relates to an architecture that can utilize special metadata to facilitate an improved advertising model in connection with media content delivery. The architecture can monitor a media player device and can launch a metadata interface on the media player device upon detection that a pause feature has been activated. Accordingly, while the media player device is paused (and therefore not presenting the media in a normal fashion), a user can interact with the metadata interface. The metadata interface can provide, e.g., advertisements or additional information related to elements or objects that exist in the media. In addition, the metadata interface can launch suitable applications in accordance with the special metadata. Additionally, the architecture can embed metadata in the media, which can be done in accordance with an advertiser bidding model.

### CROSS-REFERENCE TO RELATED APPLICATIONS

This application is related to U.S. application Ser. No. (MSFTP1973US) ______, filed on ______, entitled “SPANNING MULTIPLE MEDIUMS.” The entirety of this application is incorporated herein by reference.

### BACKGROUND

Although advertisements have historically been an integral part of media creation, advertisements that sponsor and/or subsidize media creation have conventionally been distinct from the media itself. For instance, in the domain of television, discrete commercials from the advertisers interrupt the plotline at predetermined times. For example, a beverage company might choose to sponsor a particular television show (e.g., media) with high ratings by essentially funding portions of the costs to broadcast of the show. In return, the beverage company is afforded the right to air, say, product advertisements at designated commercial time slots. In these cases, while there is a symbiotic relationship between the advertiser and the media producer, the advertisements are not directly related to the media.

Moreover, with the recent introduction and rapid growth of markets relating to digital/personal video recorders (DVR/PVR) and other devices that allow delayed media consumption, ad-skipping has become a prevalent means for consumers to avoid commercials, thus frustrating the advertiser's goals. In addition, the DVR market has also recently seen a related rise in ad-skipping mechanisms to automate this process. Accordingly, many conventional ad models simply do not work in DVR and related markets. To make matters even worse, audiences with expensive equipment such as DVRs and those who purchase ad-skipping mechanisms might be a very lucrative market segment for the advertiser if a more suitable ad model could be employed.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can utilize special metadata to facilitate an improved advertising model in connection with media content delivery. In accordance therewith and other related ends, the architecture can monitor a media player device in order to determine when a pause feature has been activated. Upon activation of the pause feature, the architecture can instantiate a metadata interface that can overlay the existing user interface of the media player device, and thus be visible and accessible by way of conventional I/O devices. For example, when a user of a digital video disc (DVD) player pauses the presentation, the metadata interface can be launched and interacted with by way of the attached television and DVD remote control.

The metadata interface can receive the special metadata embedded in the media and, based upon the contents of the special metadata, provide a variety of features. For example, the metadata interface can allow elements or objects existing in the media to become selectable in connection with associated special metadata. In addition, any element with suitable associated special metadata, upon selection (or in some cases automatically) can display data such as, e.g., advertisements or additional information. In addition, the metadata interface and also launch other applications where and when appropriate.

Accordingly, once the user is exposed to the metadata interface, elements in the media such as performers, products or items, apparel (worn by actors), landscape, setting, location, or objects therein, theme or background music, and so on can be selected. In addition, any of these elements can produce related advertisements, additional information, or launch a suitable application. Moreover, any feature provided by the metadata interface can be accessed while the media presentation remains paused.

According to another aspect of the claimed subject matter, the architecture can embed the special metadata in the media in order to facilitate an enhanced advertising model in connection with delivery of media content. The architecture can dynamically generate the special metadata upon examination of the media, and can utilize a production matrix that is populated with special metadata. In one aspect, the production matrix can be populated at the time the media is produced, which can be performed by a production crew, for example. In addition, the architecture can embed the special metadata based upon bids from advertisers such that advertisers can compete to provide the special metadata associated with one or more elements in the media.

In still another aspect of the claimed subject matter, the architecture can facilitate media sponsorship and/or improved special metadata. In one aspect, the architecture can require that the production crew populate portions of the production matrix in return for sponsorship of the media and/or production or dissemination of the media.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can utilize special metadata to facilitate an improved advertising model in connection with media content delivery.

FIG. 2 depicts a block diagram of a system that illustrates aspects associated with metadata interface in further detail.

FIG. 3 is a block diagram of a system that can embed special metadata in media in order to facilitate an improved advertising model in connection with media content delivery.

FIG. 4 illustrates a block diagram of a system that can aid with various inferences.

FIG. 5 is an exemplary flow chart of procedures that define a method for employing special metadata for facilitating an enhanced advertising model in connection with delivery of media content.

FIG. 6 illustrates an exemplary flow chart of procedures that define a method for utilizing the metadata interface in connection with facilitating an enhanced advertising model.

FIG. 7 depicts an exemplary flow chart of procedures defining a method for embedding special metadata for facilitating an enhanced advertising model in connection with delivery of media content.

FIG. 8 illustrates a block diagram of a computer operable to execute the disclosed architecture.

FIG. 9 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

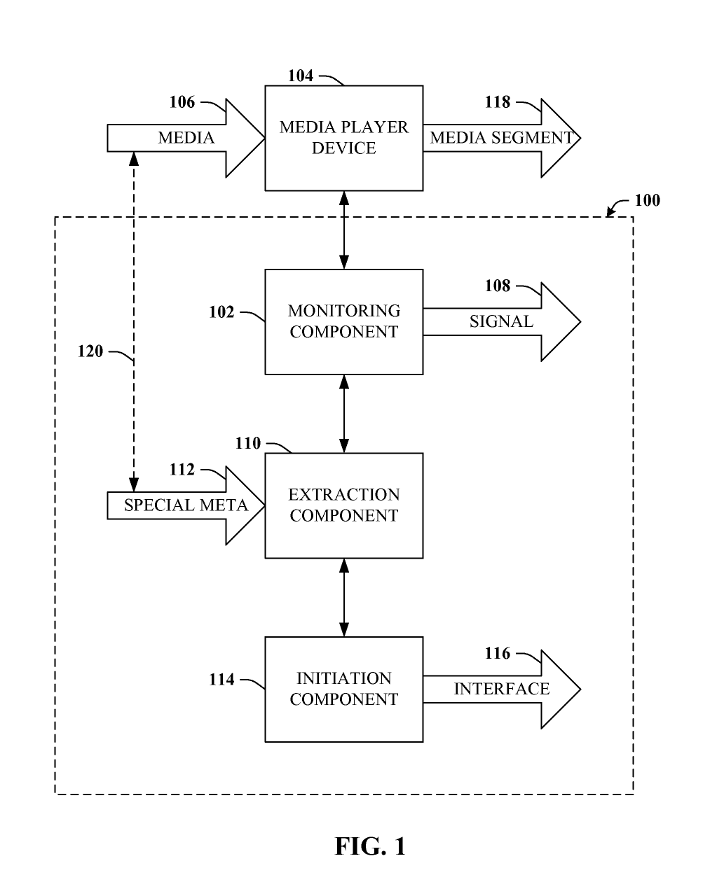

Referring now to the drawings, with reference initially to FIG. 1, system 100 that can utilize special metadata to facilitate an improved advertising model in connection with media content delivery is depicted. Generally, system 100 can include monitoring component 102 that can be operatively coupled or configured to be operatively coupled to media player device 104 that can play media 106. Media player device 104 can be substantially any media player, either hardware or software, such as a digital video recorder (DVR), a personal video recorder (PVR), a digital versatile disc (DVD) player, a video cassette recorder (VCR), a software media player (e.g., that runs on a personal computer), a gaming console, a cellular phone, a camera, a handheld or wearable device, and so on. It is to be appreciated that media player device 104 can include or be coupled to an associated user interface and other I/O devices such as a display, speakers, keyboard/keypad, navigation keys and so forth. In accordance therewith, it is readily apparent that media 106 can be substantially any video or audio media, and in some cases can be comprised of images such as, e.g., a slide show presentation.

According to an aspect of the claimed subject matter, monitoring component 102 can generate, or be configured to generate, activation signal 108 upon detection that media player device 104 has activated a pause feature. For example, most any type of media player will allow a user of the device to pause the presentation of the underlying media. In the case of video media 106 or images, the display generally freezes at the last frame displayed when the pause feature was activated, whereas with audio media 106, media player device 104 typically displays on an associated user interface the time at which media 104 was paused, which is usually gathered from, e.g. metadata embedded in media 104. In either case, when such an event occurs, monitoring component 102 can issue activation signal 108.

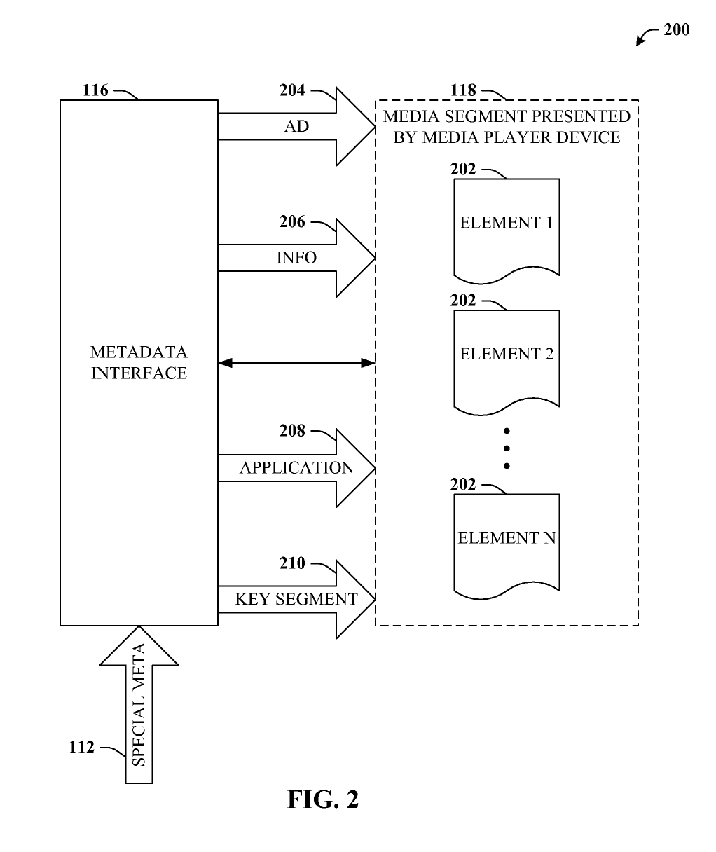

System 100 can also include extraction component 110 that can acquire (or be configured to acquire) special metadata 112. In most cases special metadata 112 will be embedded in media 104 and acquired directly there from as indicated by the broken line at reference numeral 120. In accordance therewith, it is to be appreciated that media 104 can include both metadata and special metadata 112. Examples of conventional metadata that might be included in media 104 are, e.g., sequential or non-sequential reference links, time stamps and other date or timing features, offset, certain settings or preferences, titles, headers, or names, and so on. In contrast, special metadata 112 can include, e.g. an advertisement or additional information that can relate to an element or object featured in media 104. Special metadata 112 as well as the elements or objects to which special metadata 112 can relate are described in more depth in connection with FIG. 2 infra, however, as a brief introduction, the elements featured in media 104 can be substantially any discernible feature of the presentation provided such as, e.g., performers, apparel (worn by actors), landscape, setting, location, or objects therein, theme or background music, and so on and so forth. Any of the aforementioned elements as well as other suitable elements can have associated special metadata 112.

In addition, system 100 can also include initiation component 114 that can be configured to receive activation signal 106 and that can further launch metadata interface 116 in connection with a media segment 118 that is presented by media player device 104. Appreciably, metadata interface 116 will typically be launched when the pause feature of media player device 104 has been activated (e.g., detected by monitoring component 102 and/or communicated by activation signal 106). Thus, media segment 118 will often and/or initially be the scene, frame, or track that was active at the time when media player device 104 was paused. In the case of video media 104, this scene is usually residually displayed on an output device and in the case of audio media 104, the track information and/or time-related information is usually displayed. According to one aspect of the claimed subject matter, metadata interface 116 can be launched on media player device 104, however, other aspects can exist such as launching metadata interface 116 on an independent device (not shown). As with several other features described supra, more detail in connection with metadata interface can be found with reference to FIG. 2.

Turning now to FIG. 2, system 200 illustrates aspects associated with metadata interface in further detail. System 200 can include metadata interface 116 as substantially described supra. Metadata interface 116 generally has access to media 104 either by virtue of instantiation on media player device 104 and/or based upon an association with components 102, 110, and/or 114. In a similar vein, metadata interface 116 can also have access to media segment 118 and special metadata 112. Irrespective of the particular implementation, metadata interface 116 can, upon instantiation (e.g., when media player device 104 is paused), provide a visible interface to a user of media player device 104 and can be layered on top of, supplement, and/or supplant all or portions of media segment 118 or a user interface associated with media player device 104.

In general, metadata interface 116 is not especially interested in conventional metadata that can exist in media 104. Rather, metadata interface 116 is typically primarily focused on special metadata 112 that can be embedded in media 104 and that can be associated with advertisement 204 or additional information 206 that can be associated with element 202 featured in media segment 118. In accordance therewith, metadata interface can provide for selection of one or more elements 202 featured in media segment 118. In other words, various elements 202 (e.g., audio/visual objects included and/or related to the presentation of media 104) can be tagged with special metadata that can enable these elements 202 to be selectable in some way such as by way of a menu, cursor, or other navigation features. It is to be appreciated that in the case of video media 104 and/or visual elements 202, such elements 202 can be visually highlighted or outlined.

According to an aspect of the claimed subject matter metadata interface 116 can facilitate display of advertisement 204 or additional information 206 corresponding to a selected element 202. For example, advertisement 204 or additional information 206 can be graphically or textually overlaid directly upon media segment 118 at or near selected element 202. Accordingly, a user of media player device 104 can pause device 104 during presentation of media 104 in order to activate metadata interface 116 that is, e.g., layered over media segment 118. Thereafter, the user can have access to additional menus and/or selection and navigation tools for selecting elements 202. Upon selection, advertisements 204 or additional information 206 included in special metadata 112 can be displayed. It is to be understood that in some cases no selection may be necessary. Rather, in some situations merely pausing the media player device can facilitate display of all or portions of available special metadata 112 information.

In yet another aspect of the claimed subject matter, metadata interface 116 can launch application 208 in accordance with special metadata 112 associated with selected element 202. For example, selection of element 202 can produce a call to application 206 that is more suitable to displaying advertisement 204 or additional information 206. Hence, the application can be, but is not necessarily limited to, a browser (e.g., web browser) that can be addressed to an appropriate location for accessing advertisement 204 or information 206.

According to a further aspect, metadata interface 116 can instruct media player device 104 to present key segment 210 while the pause feature is active. Thus, while media segment 118 can be the segment active when media player device 104 was paused, this need not always be or remain the case. For example, metadata interface 116 can facilitate updating what is presented by media player device 104 when the pause feature is active, and one such update can be to present instead key segment 210. Key segment 210 can be a segment, frame, or track that is particularly conducive to one or more objectives of the claimed subject matter. For instance, key segment 210 can be a segment that exemplifies the theme of media 104; that includes a substantial amount of special metadata 112; that includes a substantial number of elements 202; that includes one particular element 202; etc. It is to be appreciated that key segment 210 can be identified by special metadata 112. In addition or in the alternative, key segment 210 can be dynamically inferred by metadata interface 116 or another suitable component described herein that is operatively coupled to metadata interface 116.

In accordance with the foregoing, it should be readily appreciated that the claimed subject matter can provide for embedding potentially every segment of media 204 with special metadata 112 such that media 104 can be interwoven with advertisements 204 (or additional information 206) in an advantageous manner. One potentially unforeseen benefit of the described features can be the creation of many new advertising models that are more suitable for the growing DVR and other delayed consumption markets that, given the ability to instantly (or rapidly) skip commercials, are steadily rendering conventional ad models obsolete. Another potentially unforeseen benefit can be that advertisements 204 can be at once both ubiquitous yet imperceptible until or unless a user chooses to access them.

To provide additional context and various concrete illustrations, but not necessarily intended to limit the scope of the claimed subject matter, consider the following scenario. Ashley and Ross sit down together after dinner for a comfortable evening in front of the television. Ashley switches on the DVR (e.g., media player device 104) and selects her favorite detective show (e.g., media 106) that was recorded earlier that day while she and Ross were at work. Although the detective show airs for an hour each day, Ashley and Ross can watch the entire episode in only 40 minutes by skipping the commercials, which they both routinely do. About midway through the episode, Ross notes that the star of the show looks really cool in the sunglasses and leather jacket (e.g., elements 202 featured in media 104/media segment 118) he is wearing, so Ross would like to know what brand they are and where he can buy the same or similar brand apparel. Ashley agrees, and also points out that she also really likes the music playing in the background (e.g., element 202) during the same scene. Accordingly, Ross pauses the show, which can immediately activate metadata interface 116.

Ads, prices, descriptions, names, brands, reference links, substantially any other data can instantly appear on the paused screen. Additionally or alternatively, all or portions of these enumerated aspects can appear for individual elements 202 when selected. For example, Ross can select the sunglasses and be instantly informed of the brand, price, features or options, where to buy, where to buy similar sunglasses, comparisons or reviews, and so forth. Likewise, Ashley can select the background music (e.g. from a menu option or a music/audio icon included in metadata interface 116) to learn more about this aspect of the presentation. In either case, a browser or other application 208 can be launched to further enhance the functionality of metadata interface 116. For example, a music application can be launched to facilitate the purchase, download, and/or archival of the song Ashley appreciated.

To continue this example, near the end of the detective show, the protagonist must rescue his co-star from the villain's desert stronghold. In the background of one of the scenes, Ross notices a rather interesting scrubby-looking tree that has something vaguely interesting and familiar about it. Ross pauses the show, selects the tree and learns that the tree is a bristlecone pine (Pinus longaeva), which are believed to be the oldest single living organisms on the planet, capable of reaching ages approaching 5,000 years. Hence, in addition to advertisements 204, informative and/or interesting additional information 206 can be displayed as well. Essentially, any information that can be included in or referenced by special metadata 116 can be utilized in this or a similar manner.

At the climax of the detective show, the hero finally meets the guest-star villain at his tropical resort. Ashley recognizes the guest-star, but cannot seem to recall his name. Accordingly, she pauses the show, selects the villain. As one example, metadata interface 116 can launch a viewer that is directed to a well-known site for movies and actors, which includes a bio and filmography for many of the listed actors. Ross on the other hand is more interested in the tropical locale. By way of metadata interface 116, Ross selects an option for the setting of the scene and is taken to a well-known website for vacation and resort scheduling.

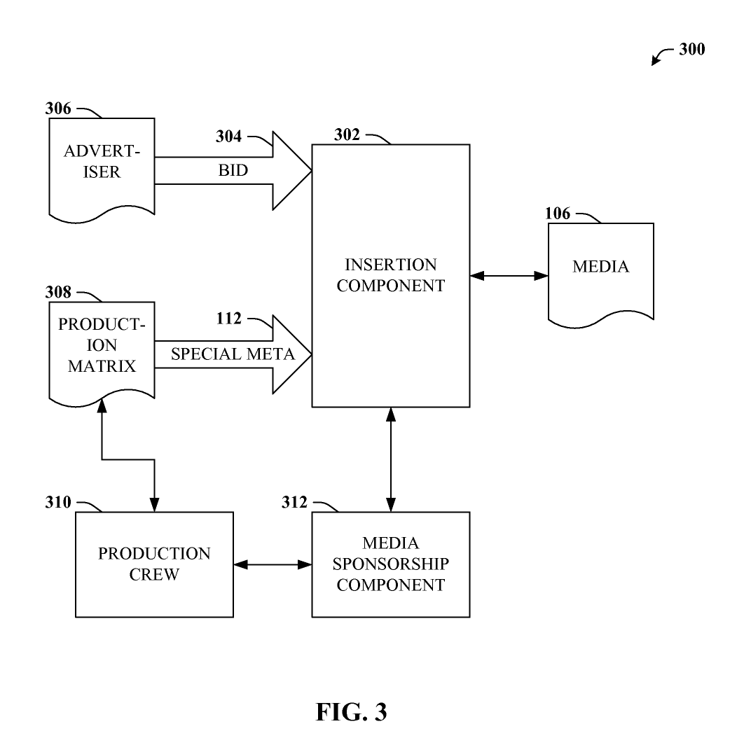

With reference now to FIG. 3, system 300 that can embed special metadata in media in order to facilitate an improved advertising model in connection with media content delivery is provided. Generally, system 300 can include insertion component 302 that can receive media 106 and can embed special metadata 116 in media 106. In one aspect, insertion component can acquire special metadata 116 from production matrix 308, which can be a data store for special metadata 116. Additionally or alternatively, insertion component 308 can dynamically generate special metadata 116 based upon a variety of factors. For example, insertion component 302 can generate and embed special metadata 116 based upon an examination of media 106, where, e.g. elements 202 are identified and tagged. As another example, insertion component 302 can generate and/or embed special metadata 116 based upon a bid from an advertiser. For instance, several advertisers may be interested in certain elements 202, hence, these advertisers can compete with bids, where the bid winner can select the special metadata 116 that is embedded for that element 202.

It should be emphasized that insertion component 302 can be advantageously employed to embed special metadata 116 at the same time the media is being produced. Thus, e.g. insertion component 302 can be employed by a production staff or crew (e.g., production crew 310) while much “behind-the-scenes” information is more readily available. Additionally or alternatively, the production crew 310 can contribute to populating production matrix 308 during production of media 106.

System 300 can also include media sponsorship component 312 that can, e.g., facilitate advertising and/or sponsorship models more conducive to DVR audiences. For instance, media sponsorship component 312 can require production crew 310 to populate production matrix 308 in return for sponsorship. To use the aforementioned detective show as an example, one conventional means of sponsorship is by way of advertisers that provide sponsorship in return for commercial slots. As DVR audiences can readily skip these commercials, thereby frustrating the advertisers' goals, the advertiser can pay instead for the population of production matrix 308. Thus, the advertiser can leverage behind-the-scenes information and potentially oversee the contents of production matrix 308 such that that particular advertiser's content is included as well.

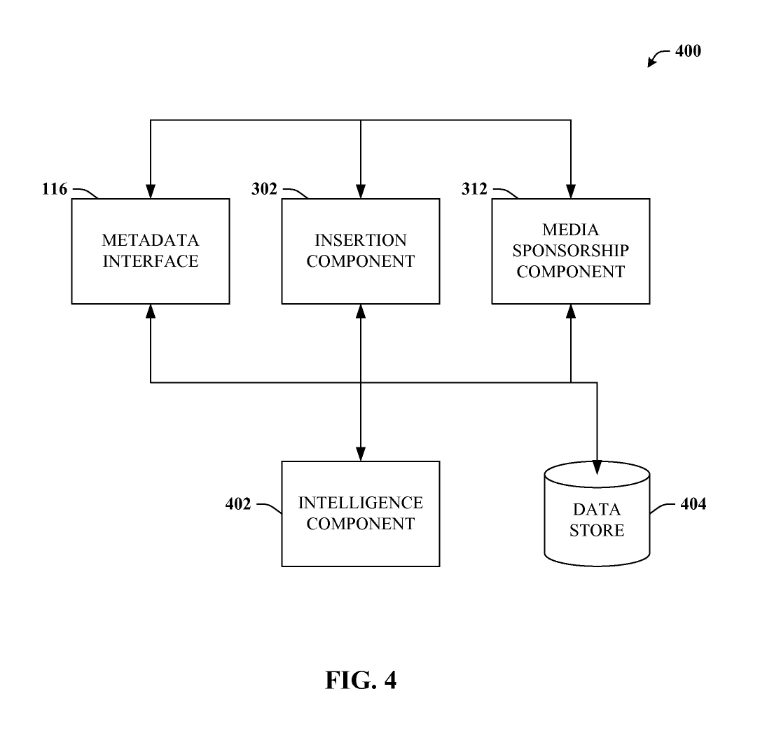

Turning now to FIG. 4, system 400 that can aid with various inferences is depicted. In general, system 400 can include metadata interface 116 that can, e.g. intelligently determine which special metadata 116 to display. For example, element 202 may be associated with a large amount of special metadata 116 and metadata interface 116 can intelligently select which portions to display based upon, e.g., user preferences, histories, demographics, screen size, position, etc. As another example, in some cases as described herein, no particular element 202 need be selected for special metadata 116 to be displayed. For instance, the act of pausing media player device 104 can automatically activate display of some or all of the available special metadata 116. Thus, in this situation, metadata interface 116 can intelligently select which portions of special metadata to display. Additionally, metadata interface 116 can also intelligently determine key segment 210 as described supra.

System 400 can also include insertion component 302 that can intelligently examine media 104 to embed special metadata 116 in media 104 based upon, e.g., element 202 identification and/or advertiser bidding. Furthermore, system 400 can include media sponsorship component 312 that can intelligently oversee the population of production matrix 308.

In addition, system 400 can also include intelligence component 402 that can provide for or aid in various inferences or determinations. It is to be appreciated that intelligence component 402 can be operatively coupled to all or some of the aforementioned components. Additionally or alternatively, all or portions of intelligence component 402 can be included in one or more of the components 116, 302, 312. Moreover, intelligence component 402 will typically have access to all or portions of data sets described herein, such as data store 404, and can furthermore utilize previously determined or inferred data.

Accordingly, in order to provide for or aid in the numerous inferences described herein, intelligence component 402 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

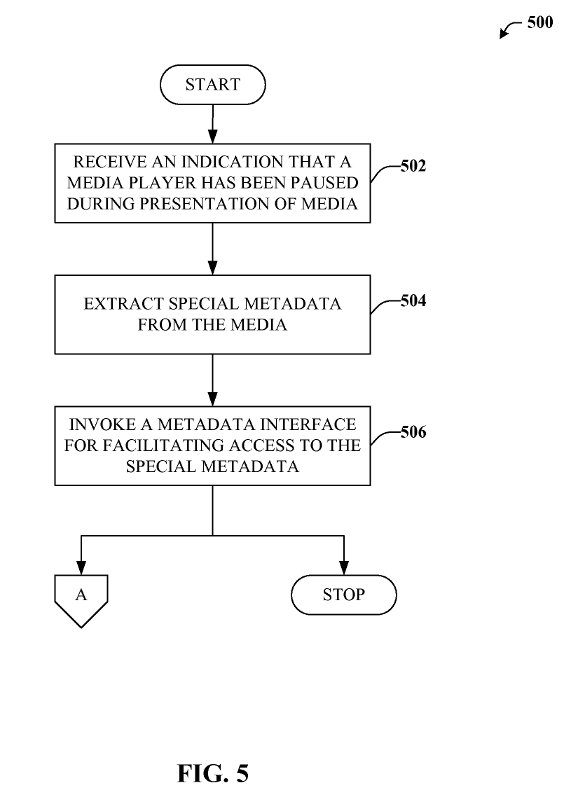

FIGS. 5, 6, and 7 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 5, exemplary method 500 for employing special metadata for facilitating an enhanced advertising model in connection with delivery of media content is illustrated. Typically, at reference numeral 502, an indication that a media player device has activated a pause feature during presentation of media can be received. For example, the media player device can be operatively coupled to or be embedded with a component for monitoring the media player device and/or the monitoring for an associated pause feature activation.

At reference numeral 504, special metadata can be read or extracted from the media. As the name implies, special metadata can be materially distinct from conventional metadata in that conventional metadata usually includes items relating to timing or references associated with reading the media. In contrast, special metadata typically relates to objects or elements that are presented in the media

At reference numeral 506, a metadata interface for facilitating access to the special metadata can be invoked. Appreciably, the metadata interface can be invoked in connection with a media segment presented by the media player device. In particular, the media segment can be that which is presented/displayed at the time the media player device activated the pause feature.

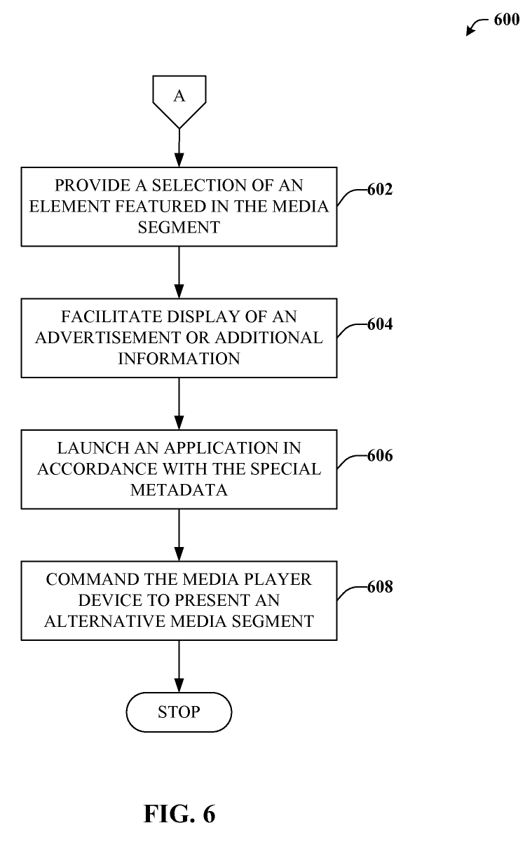

Referring to FIG. 6, exemplary method 600 for utilizing the metadata interface in connection with facilitating an enhanced advertising model is depicted. In general, at reference numeral 602, a selection of an element featured in the media segment can be provided. The selection can be provided based upon associated special metadata. For example, the special metadata can supply a tag or handle to the element such that the element is selectable by way of the metadata interface.

At reference numeral 604, display of an advertisement or additional information can be facilitated. The advertisement and/or additional information can be included in or referenced by the special metadata corresponding to the selected element. For example, the selected element can be an actress appearing in the media and, upon selection, additional information can be displayed such as a biography/filmography for the actress. Likewise, an advertisement can be displayed such as an advertisement relating to the dress worn by the actress at the displayed segment.

At reference numeral 606, an application can be launched in accordance with the special metadata associated with the selected element. Thus, alternatively or in addition to displayed content such as the advertisement or additional information detailed at act 604, supra, an application can also be launched. The application can be a browser (e.g., web browser, content browser . . . ) or substantially any suitable utility or applet.

Next, at reference numeral 608, the media player device can be commanded to present an alternative media segment. In more detail, when media is paused, the active segment can be useful in many ways and can provide a natural segue into use of the metadata interface. However, other segments can also be appropriate or useful. For example, the special metadata can include information relating to a key segment that, e.g., includes a large amount of special metadata and/or is especially important to the media author, sponsor, user, or some other party. Therefore, the metadata interface can instruct the media player device to display the key segment, however, it should be appreciated that other segments can be displayed as well, even those that are not designated or inferred to be key segments.

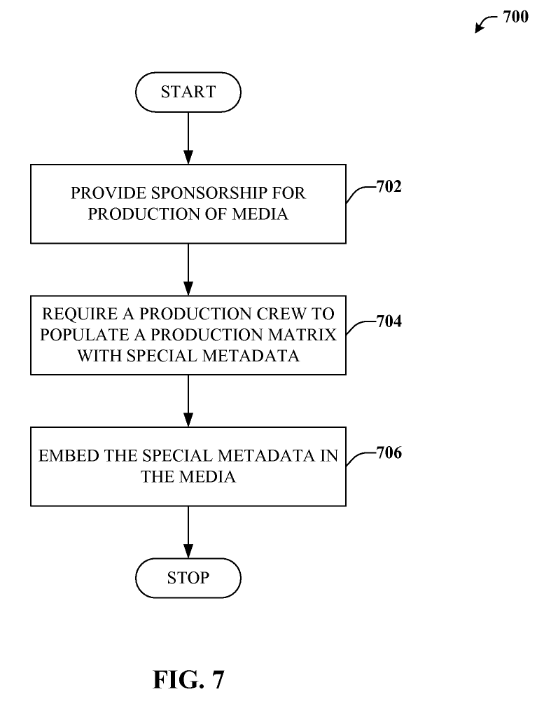

Turning briefly to FIG. 7, method 700 for embedding special metadata for facilitating an enhanced advertising model in connection with delivery of media content is illustrated. Generally, at reference numeral 702, sponsorship for production of media can be provided. For example, the sponsorship can be in the form of financial support or backing, and such support can be related directly to the production of the media. In some cases the support can be related to the dissemination of the media and direct to broadcast networks as is the case in conventional advertising (e.g., advertisers pay broadcast networks for airing commercials, so the advertiser pays the network for the commercials run at the time slot the media is aired by the network).

At reference numeral 704, a production crew can be required to populate a production matrix with special metadata in return for the sponsorship described at act 702. The production matrix can include advertisements or additional information that is utilized in connection with the special metadata. The advertisements can be related to the sponsor providing sponsorship and the additional information can be information that is more easily obtain during the creation of the media or by the media authors who usually have a unique if not inside perspective about the media. Thus, the sponsorship can be provided in exchange for population of the production matrix.

At reference numeral 706, the special metadata can be embedded in the media. Accordingly, the information included in the production matrix (or some other source or dynamically generated on the fly) can be transformed into special metadata and associated with various suitable elements in the media. In this manner, the elements can be tagged with the special metadata, which can provide portals to the information included in the special metadata by way of a metadata interface. Therefore, a user of a media player can be exposed to the many features described herein by activating the metadata interface, which can occur automatically when the user pauses the presentation of the media.

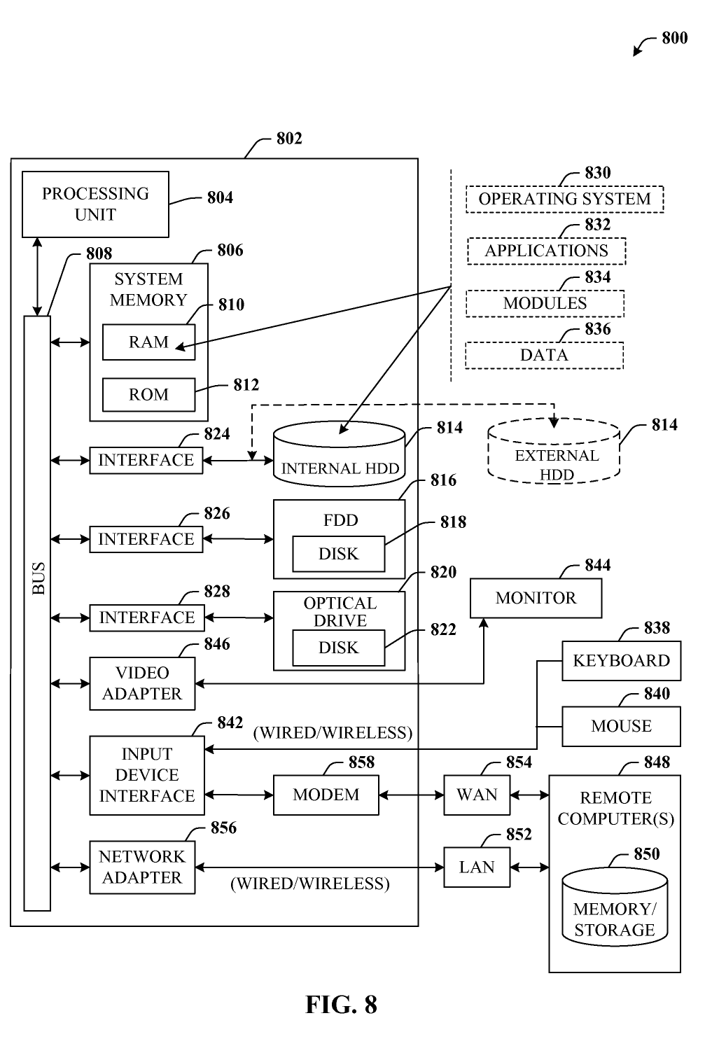

Referring now to FIG. 8, there is illustrated a block diagram of an exemplary computer system operable to execute the disclosed architecture. In order to provide additional context for various aspects of the claimed subject matter, FIG. 8 and the following discussion are intended to provide a brief, general description of a suitable computing environment 800 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the claimed subject matter includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g. reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the claimed subject matter can be implemented with various commercially available operating systems or combinations of operating systems.

A user can enter commands and information into the computer 802 through one or more wired/wireless input devices, e.g. a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g. the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

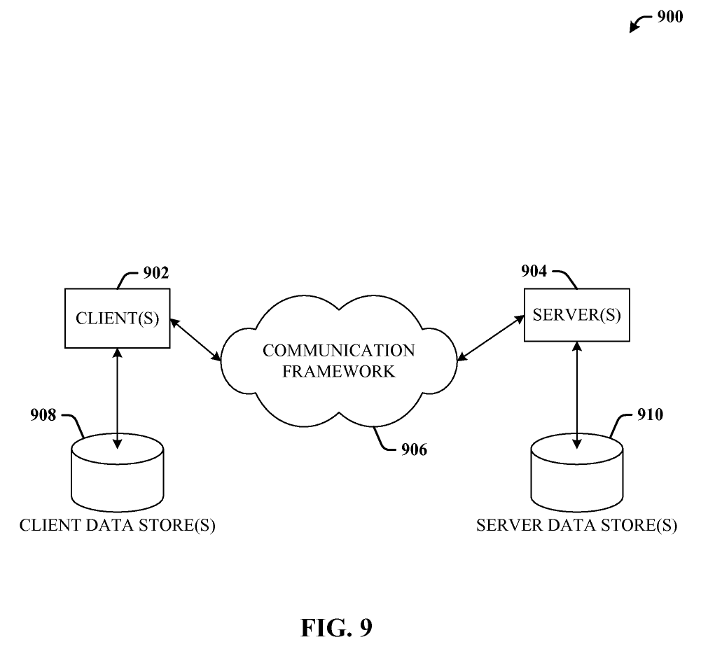

Referring now to FIG. 9, there is illustrated a schematic block diagram of an exemplary computer compilation system operable to execute the disclosed architecture. The system 900 includes one or more client(s) 902. The client(s) 902 can be hardware and/or software (e.g., threads, processes, computing devices). The client(s) 902 can house cookie(s) and/or associated contextual information by employing the claimed subject matter, for example.

The system 900 also includes one or more server(s) 904. The server(s) 904 can also be hardware and/or software (e.g., threads, processes, computing devices). The servers 904 can house threads to perform transformations by employing the claimed subject matter, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g. a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that utilizes special metadata to facilitate an improved advertising model in connection with media content delivery, comprising:
a monitoring component that is configured to operatively couple to a media player device that plays media, the monitoring component is configured to generate an activation signal upon detection that the media player device has activated a pause feature;
an extraction component that is configured to acquire special metadata embedded in the media; and
an initiation component that is configured to receive the activation signal and to launch a metadata interface in connection with a media segment presented by the media player device.

2. The system of claim 1, the media is at least one of video or audio, and the media segment is at least one of a frame, a track, or a portion of a track.

3. The system of claim 1, the media segment presented by the media player device is the media segment active when the media player device is paused.

4. The system of claim 1, the media includes both metadata and the special metadata.

5. The system of claim 1, the special metadata includes an advertisement that relates to an element featured in the media segment.

6. The system of claim 1, the special metadata includes additional information that relates to an element featured in the media segment.

7. The system of claim 1, the initiation component launches the metadata interface on the media player device.

8. The system of claim 1, the metadata interface provides for selection of an element featured in the media segment, the element is associated with the special metadata.

9. The system of claim 1, the metadata interface facilitates display of an advertisement or additional information corresponding to a selected element.

10. The system of claim 1, the metadata interface launches an application in accordance with the special metadata associated with a selected element.

11. The system of claim 1, the metadata interface instructs the media player device to present a key segment while the pause feature is active.

12. The system of claim 11, the key segment is identified by the special metadata.

13. The system of claim 11, the key segment is dynamically inferred based upon at least one of a substantial amount of special metadata is associated with the key segment, a substantial number of elements are featured in the key scene, or a particular element is featured in the key scene.

14. The system of claim 1, further comprising an insertion component that receives the media segment and that embeds the special metadata in the media segment.

15. The system of claim 14, the insertion component acquires the special metadata from a production matrix; or dynamically generates the special metadata based upon at least one of an examination of the media or a bid from an advertiser.

16. The system of claim 15, the production matrix is populated with special metadata by a production crew at a time in which the media is produced.

17. The system of claim 16, further comprising a media sponsorship component that requires the production crew to populate the production matrix in return for sponsorship of production of the media.

18. A method for employing special metadata for facilitating an enhanced advertising model in connection with delivery of media content, comprising:
receiving an indication that a media player device has activated a pause feature during presentation of media;
extracting special metadata from the media; and
invoking a metadata interface for facilitating access to the special metadata in connection with a media segment presented by the media player device.

19. The method of claim 18, further comprising at least one of the following acts:
providing a selection of an element featured in the media segment in connection with the special metadata;
facilitating display of an advertisement or additional information included in the special metadata corresponding to a selected element;
launching an application in accordance with the special metadata associated with the selected element; or
commanding the media player device to present an alternative media segment.

20. A method for embedding special metadata for facilitating an enhanced advertising model in connection with delivery of media content, comprising:
providing sponsorship for production of media;
requiring a production crew to populate a production matrix with special metadata in return for the sponsorship; and
embedding the special metadata in the media.
